(19) United States
(12) Patent Application Publication
(10) Pub. No.: US 2019/0221976 A1
(43) Pub. Date: Jul. 18, 2019

(54) ELECTRONIC DEVICE WITH REPLACEABLE ADAPTER

(71) Applicant: Getac Technology Corporation, Hsinchu County (TW)

(72) Inventors: Hsin-Chih CHOU, Taipei (TW); Juei-Chi CHANG, Taipei (TW)

(21) Appl. No.: 16/031,117

(22) Filed: Jul. 10, 2018

(30) Foreign Application Priority Data
Jan. 12, 2018 (CN) 201810029808.0

(51) Int. Cl. H01R 31/06; H01R 13/74; G06F 1/16

(52) U.S. Cl. CPC H01R 31/06; H01R 12/722; G06F 1/1656; H01R 13/748

(57) ABSTRACT

An electronic device with replaceable adapter includes a case, circuit board, connector, adapter and fastening member. The connector has one end electrically connected to the circuit board and other end having a first connection terminal. The first connection terminal is disposed in the case and facing an opening thereof. The adapter includes a body, second connection terminal, third connection terminal and fixing portion. The second and third connection terminals are disposed at two opposite ends of the body, respectively, and electrically connected to each other. The fixing portion is disposed at the body and positioned proximate to the third connection terminal. The body is penetratingly disposed at the opening to enable insertion of the second connection terminal into the first connection terminal and allow the fixing portion to abut against the case. The fastening member penetrates the fixing portion and is fastened to an outer surface of the case.

### RELATED APPLICATIONS

This application claims priority to Chinese application serial number 201810029808.0, filed Jan. 12, 2018, which is herein incorporated by reference.

### BACKGROUND OF THE INVENTION

### Field of the Invention

The present invention relates to electronic devices and more particularly to an electronic device with a replaceable adapter which is easy to demount and mount.

### Description of the Prior Art

To be chargeable or capable of transmitting data, various electronic devices must be equipped with a connector. However, charging or data transmission is carried out as needed, and thus the connector is often plugged and unplugged. Conventional connectors, such as USB 2.0/3.0/3.1, have drawbacks: owing to improper user behavior, a connector may be inserted from a wrong angle or in a wrong direction, causing its contacts to sever or preventing the contacts from touching each other sufficiently; and in a severe scenario, it fails.

Every conventional USB connector is mounted on a circuit board of an electronic device by surface-mount technology (SMT) or fixed in place inside a casing of an electronic device while being connected to a cable. In case of a failure of the USB connector, the electronic device must be entirely delivered to a maintenance center. As a result, the prior art is disadvantaged by high maintenance costs, lengthy maintenance processes, and inconvenience experienced by users waiting for the return of electronic devices from maintenance centers.

### SUMMARY OF THE INVENTION

In view of the aforesaid drawbacks of the prior art, it is an objective of an embodiment of the present invention to provide an electronic device with replaceable adapter. The electronic device comprises a case, a circuit board, a connector, an adapter and at least a fastening member. The case has an opening. The circuit board is disposed in the case. The connector has one end disposed at and electrically connected to the circuit board. The other end of the connector has a first connection terminal. The first connection terminal is disposed in the case and faces the opening. The adapter comprises a body, a second connection terminal, a third connection terminal and at least a fixing portion. The second connection terminal and the third connection terminal are disposed at two opposite ends of the body, respectively, and electrically connected to each other. The at least a fixing portion is disposed at the body and positioned proximate to the third connection terminal. The body is penetratingly disposed at the opening of the case. The second connection terminal is insertedly disposed at the first connection terminal. The at least a fixing portion abuts against the case. The at least a fastening member is passed through the at least a fixing portion and fastened to the outer side of the case.

An embodiment of the present invention provides an electronic device for use with an adapter replaceable. The electronic device comprises a case, a circuit board and a connector. The case has an opening. The circuit board is disposed in the case. The connector has one end fixedly disposed at and electrically connected to the circuit board. The other end of the connector is connected to one end of the adapter. The other end of the adapter is exposed from the opening but demountably and mountably disposed at the case.

Another embodiment of the present invention provides an electronic device with replaceable adapter. The electronic device comprises a case, a circuit board, a connector and an adapter. The case has an opening. The circuit board is disposed in the case. One end of the connector is fixedly disposed at and electrically connected to the circuit board. One end of the adapter is connected to the other end of the connector. The other end of the adapter is exposed from the opening but demountably and mountably disposed at the case.

Therefore, given a replaceable adapter designed to be demounted and mounted by users independently, if the replaceable adapter gets damaged as a result of multiple instances of plugging and unplugging, the users will just have to purchase the replaceable adapter independently or purchase the replaceable adapter through the manufacturer and then replace the replaceable adapter independently, thereby dispensing with the hassles of returning the electronic device entirely to the manufacturer for maintenance. With the replaceable adapter being easy to replace and mount, the users can replace the replaceable adapter conveniently, easily, and with no likelihood of the users damaging the adapter in the course of replacement. Therefore, the present invention reduces maintenance costs and speeds up maintenance processes.

### BRIEF DESCRIPTION OF THE DRAWINGS

FIG. 1 is a partial schematic view of an electronic device according to the first embodiment of the present invention;

FIG. 2 is a partial schematic exploded view of the electronic device according to the first embodiment of the present invention; and

FIG. 3 is a partial cutaway view of the electronic device according to the first embodiment of the present invention.

### DETAILED DESCRIPTION OF THE EMBODIMENTS

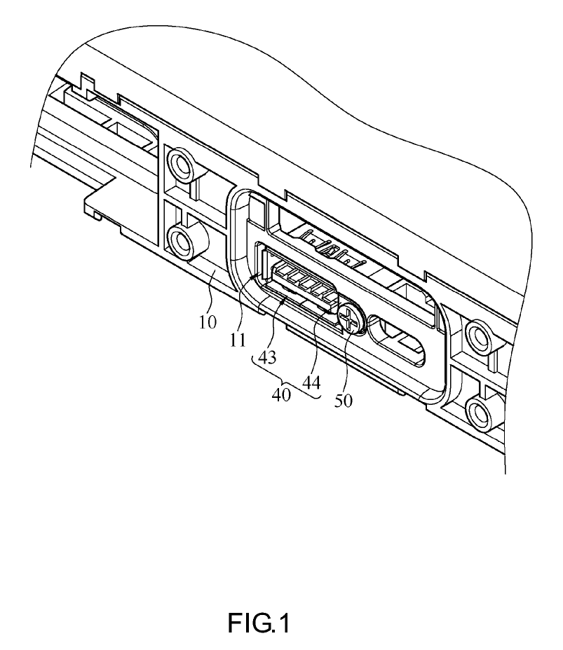

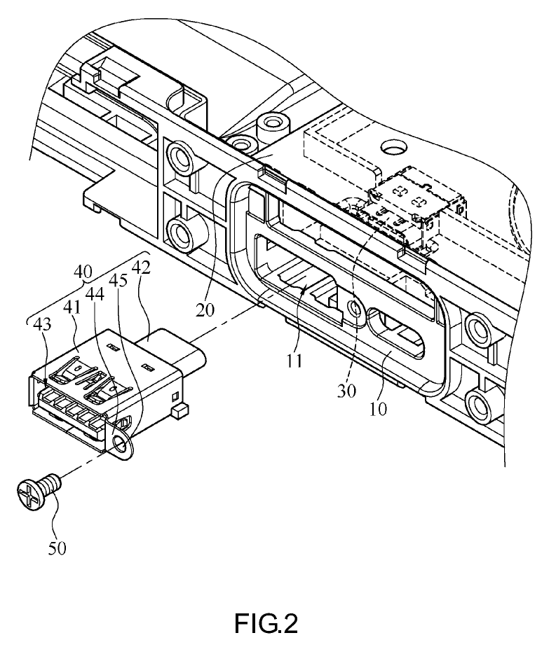

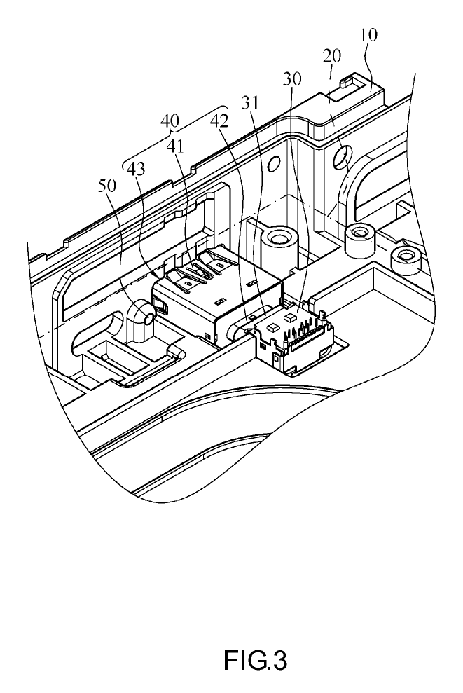

Referring to FIG. 1 through FIG. 3, there are shown in FIG. 1 a partial schematic view of an electronic device according to the first embodiment of the present invention, in FIG. 2 a partial schematic exploded view of the electronic device according to the first embodiment of the present invention, and in FIG. 3 a partial cutaway view of the electronic device according to the first embodiment of the present invention. In this embodiment, the electronic device has a replaceable adapter and comprises a case 10, a circuit board 20, a connector 30, an adapter 40 and a fastening member 50. The electronic device, which can be a notebook computer, a tablet or a mobile device, requires a connector in order to be chargeable or capable of transmitting data. In this embodiment, the electronic device is exemplified by a notebook computer for the sake of description. An upper lid of the case 10 is omitted from FIG. 2 and FIG. 3 so that the inside of the case 10 is visible and shown in the diagrams. The circuit board 20 as well as pins extended from the connector 30 and soldered to the circuit board 20 are omitted from FIG. 2, but the connector 30 is depicted by a dashed line in FIG. 2. FIG. 3 is a partial cutaway view of the circuit board 20 to show the connection of the connector 30 and the adapter 40.

The case 10 has an opening 11. The opening 11 is disposed on any side of the case 10 to facilitate the plugging and unplugging of the connector 30. The circuit board 20 is disposed in the case 10. In this embodiment, a portion of the circuit board 20 is positioned proximate to the opening 11. The connector 30 has one end disposed at and electrically connected to the circuit board 20. In this embodiment, the one end of the connector 30 is directly soldered to the circuit board 20. In a variant embodiment, the one end of the connector 30 is inserted into the circuit board 20. The other end of the connector 30 has a first connection terminal 31. The first connection terminal 31 is disposed in the case 10 and faces the opening 11. Hence, when the connector 30 is disposed at the circuit board 20, the connector 30 is disposed inside rather than exposed from the case 10. To allow a second connection terminal 42 of the adapter 40 to be precisely inserted into the first connection terminal 31 of the connector 30, the first connection terminal 31 of the connector 30 faces the opening 11. Owing to the position-limiting function of the opening 11, the second connection terminal 42 of the adapter 40 can be smoothly inserted into and connected to the first connection terminal 31 of the connector 30.

One end of the adapter 40, that is, the second connection terminal 42, is connected to the other end of the connector 30, that is, the first connection terminal 31. The other end of the adapter 40, that is, a third connection terminal 43, is exposed from the opening 11 as well as demountably and mountably disposed at the case 10. As shown in FIG. 2 and FIG. 3, the adapter 40 comprises a body 41, a second connection terminal 42, a third connection terminal 43 and a fixing portion 44. The second connection terminal 42 and the third connection terminal 43 are disposed at two opposite ends of the body 41, respectively, and electrically connected to each other. The fixing portion 44 is disposed at the body 41 and positioned proximate to the third connection terminal 43. In this embodiment, a casing of the body 41 and the fixing portion 44 are integrally formed by sheet metal stamping, wherein the fixing portion 44 integrally formed with the casing by stamping is fixed to the outer side of the case 10 to allow a user to demount and mount the adapter 40 from outside subsequently and independently. To assemble the electronic device, the body 41 is penetratingly disposed at the opening 11 of the case 10, and the second connection terminal 42 is insertedly disposed at the first connection terminal 31. As soon as the body 41 is inserted to cause the second connection terminal 42 to be insertedly disposed at the first connection terminal 31, the fixing portion 44 abuts against the case 10 and then is fastened to the case 10 by the fastening member 50.

Afterward, the fastening member 50 is passed through the fixing portion 44 and fastened to the outer side of the case 10. In this embodiment, the fastening member 50 is exemplified by a screw whereby the fixing portion 44 is fastened to the case 10. In a variant embodiment, the fixing portion 44 is snap-engaged with or fitted tightly to the case 10. The fastening member 50 and the fixing portion 44 may also be in a plural number and correspond in position to each other such that the fastening members 50 are passed through the fixing portions 44 and fastened thereto, respectively.

As the connector 30 is fixed in place inside the case 10 but is not plugged and unplugged repeatedly, the connector 30 neither gets damaged readily nor needs to be replaced. At this point in time, the replaceable adapter 40 which users can easily demount and mount is mounted on the electronic device. If the adapter 40 gets damaged after being plugged and unplugged frequently, a user may purchase a new adapter independently or purchase a new adapter through the manufacturer. Afterward, the user changes the adapter 40 independently, thereby dispensing with the hassles of delivering the electronic device to the manufacturer for repair. With the adapter 40 being designed to facilitate replacement and mounting, users can replace the adapter 40 conveniently, easily, and with no likelihood of the users damaging the adapter 40 in the course of replacement. Therefore, the present invention reduces maintenance costs and speeds up maintenance processes.

In this embodiment, the third connection terminal 43 is a USB Type A connection terminal currently in wide use by electronic devices for charging and transmitting data. In a variant embodiment, the third connection terminal 43 is a USB Type A connection terminal, a USB Type B connection terminal, a USB Type C connection terminal, a USB Mini A connection terminal, a USB Mini B connection terminal, a USB Micro A connection terminal or a USB Micro B connection terminal, as needed.

In some variant embodiments, both the first connection terminal 31 and the second connection terminal 42 are USB Type C connection terminals, and thus the second connection terminal 42 is connected to the first connection terminal 31 of the connector 30 in dual orientations. An interface connected between the connector 30 and the adapter 40 has 2-fold rotational symmetry (attributed to characteristics of USB Type-C interfaces), and thus the adapter 40 can be forwardly or reversely inserted into the connector 30. Therefore, after being rotated about the direction of connection by 180°, the adapter 40 can still be connected to the connector 30. Hence, the chance that a user will damage the connector 30 disposed in the case 10 is precluded, because the user is prevented from inserting the adapter 40 into the case 10 in a wrong direction forcefully.

In some variant embodiments, the second connection terminal 42 is a USB Type A connection terminal, a USB Type B connection terminal, a USB Mini A connection terminal, a USB Mini B connection terminal, a USB Micro A connection terminal or a USB Micro B connection terminal. The first connection terminal 31 and the second connection terminal 42 are jack and plug of the same type of USB connectors, respectively, such that the second connection terminal 42 can be plugged into the first connection terminal 31. If the connector interface in use requires plugging in a specific direction, the fixing portion 44 will enable foolproofing. For instance, in this embodiment, the fixing portion 44 exists unilaterally to ensure that the adapter 40 must be inserted into the connector 30 in one and only one direction before being fastened thereto. When it comes to a connector capable of forward or reverse insertion (such as the aforesaid USB Type-C interface), the fixing portion 44 may be disposed on both sides of the body 41 such that the adapter 40 can be fastened in place even after being rotated by 180°.

In some variant embodiments, the second connection terminal 42 and the third connection terminal 43 are USB connection terminals of the same type as needed. It is also feasible that the second connection terminal 42 and the third connection terminal 43 are USB connection terminals of different types as needed. In this embodiment, the connector 30 is a jack connector compatible with USB Type-C interfaces, whereas two ends of the adapter 40 are a jack connector front end connection terminal compatible with USB Type-A interfaces and a plug connector front end connection terminal compatible with USB Type-C interfaces, respectively. In another embodiment, the adapter 40 is for use in changing a jack connector front end connection terminal and a plug connector front end connection terminal which are compatible with interfaces of the same type or of different types, wherein the second connection terminal 42 of the adapter 40 and the first connection terminal 31 of the connector 30 are compatible with interfaces of the same type to facilitate connection of the adapter 40 and the connector 30. Therefore, the second connection terminal 42 connects with the first connection terminal 31, whereas the third connection terminal 43 enables the electronic device to connect with a peripheral apparatus. Even if the third connection terminal 43 gets damaged under an external force, the first connection terminal 31 will remain intact, and in consequence the connector 30 soldered and fixed to the circuit board 20 will remain unaffected. Hence, maintenance solely entails replacing the adapter 40, thereby dispensing users with the hassles of delivering the electronic device to the manufacturer for replacement of the circuit board 20 or for a redo in order to replace the connector 30 soldered and fixed to the circuit board 20. Moreover, considering subsequent maintenance or replacement of the connector 30 is not the issue, the connector 30 is irreversibly fixed to the circuit board 20. Although the interface connected between the connector 30 and the adapter 40 is a USB Type-C interface, the two ends of the adapter 40 are changed from a USB Type A jack connector to a USB Type-C plug connector and thus need not be fully USB Type-C-compatible. Therefore, the connector 30 merely needs to be USB Type-A-compatible, thereby simplifying the specification of the connector 30 or the second connection terminal 42.

Referring to FIG. 2, in this embodiment, the fixing portion 44 is a blocking plate with a through hole 45. The fastening member 50 passes through the through hole 45 to fasten the adapter 40 to the case 10. The diameter of the through hole 45 is slightly greater than the outer diameter of a portion of fastening member 50, as the portion of the fastening member 50 is penetratingly disposed at the through hole 45. A stop portion is disposed at one end of the fastening member 50. The maximum outer diameter of the stop portion is greater than the diameter of the through hole 45 such that the fixing portion 44 can be fixed to the case 10.

In this embodiment, the opening 11 corresponds in shape to the rim of the third connection terminal 43, that is, the third connection terminal 43 matches the opening 11 in shape; hence, after the body 41 has been penetratingly disposed at the opening 11, the third connection terminal 43 fills the opening 11 exactly. In a variant embodiment, the body 41 is made slightly smaller than the opening 11, enclosed by an 0-ring, and then penetratingly disposed at the opening 11. Hence, the junction of the adapter 40 and the case 10 is waterproof.

Although the present invention is disclosed above by the aforesaid embodiments, the embodiments are not restrictive of the present invention. Any persons skilled in the art can make some changes and modifications to the embodiments without departing from the spirit and scope of the present invention. Accordingly, the legal protection for the present invention should be defined by the appended claims.

What is claimed is:

1. An electronic device with replaceable adapter, comprising:
a case having an opening;
a circuit board disposed in the case;
a connector with an end disposed at and electrically connected to the circuit board and another end having a first connection terminal, the first connection terminal being disposed in the case and facing the opening;
an adapter comprising a body, a second connection terminal, a third connection terminal and at least a fixing portion, wherein the second connection terminal and the third connection terminal are disposed at two opposite ends of the body, respectively, and electrically connected to each other, with the at least a fixing portion disposed at the body and positioned proximate to the third connection terminal, the body penetratingly disposed at the opening of the case, the second connection terminal insertedly disposed at the first connection terminal, and the at least a fixing portion abutting against the case; and
at least a fastening member passed through the at least a fixing portion and fastened to an outer side of the case.

2. The electronic device with replaceable adapter according to claim 1, wherein the third connection terminal is a USB Type-A connection terminal.

3. The electronic device with replaceable adapter according to claim 2, wherein the first connection terminal and the second connection terminal are jack and plug of the same type of USB connectors, respectively.

4. The electronic device with replaceable adapter according to claim 1, wherein the at least a fixing portion is a blocking plate with a through hole.

5. The electronic device with replaceable adapter according to claim 1, wherein the opening corresponds in shape to a rim of the third connection terminal.

6. An electronic device, for use with an adapter replaceable, comprising:
a case having an opening;
a circuit board disposed in the case; and
a connector with an end fixedly disposed at the circuit board and another end connected to one end of the adapter such that another end of the adapter is exposed from the opening but demountably and mountably disposed at the case.

7. The electronic device of claim 6, wherein the one end of the adapter is connected to the another end of the connector bidirectionally.

8. An electronic device with replaceable adapter, comprising:
a case having an opening;
a circuit board disposed in the case;
a connector with an end fixedly disposed at the circuit board; and
an adapter with one end connected to another end of the connector, wherein another end of the adapter is exposed from the opening but demountably and mountably disposed at the case.

9. The electronic device with replaceable adapter according to claim 8, wherein the one end of the adapter is connected to the another end of the connector bidirectionally.

10. The electronic device with replaceable adapter according to claim 8, wherein a casing of the adapter has a fixing portion and the fixing portion is fixed to an outer side of the case.
